(19) United States
(12) Patent Application Publication
(10) Pub. No.: US 2008/0302836 A1
(43) Pub. Date: Dec. 11, 2008

(54) Multipart Plastic Closure

(76) Inventor: Lorenz Mathis, Schlins (AT)

Correspondence Address: PAULEY PETERSEN & ERICKSON, 2800 WEST HIGGINS ROAD, SUITE 365, HOFFMAN ESTATES, IL, 60195, US

(21) Appl. No.: 11/886,016

(22) PCT Filed: Mar. 1, 2006
(86) PCT No.: PCT/CH06/00126

§ 371 Date: Jun. 2, 2008

(30) Foreign Application Priority Data
Mar. 9, 2005 (CH) 405/05

(51) Int. Cl. B67D 3/00

(52) U.S. Cl. 222/521

(57) ABSTRACT

A multi-part plastic closure that accommodates an increased inner pressure in the receptacle on which the closure is attached, while avoiding deformations which compromise the tightness or sealing of the closure. The corresponding multi-part plastic closure includes a lower part having a first region with a lateral surface, with an inner thread for screwing onto a receptacle, and which is closed to the top by a pour-out mouth or spout. The pour-out mouth or spout includes a top surface or covering area which is reduced as an annular sealing surface and is reinforced by stiffening. A centric pour-out opening or central spout is provided with a sealing, and a sealing plug or peg which is integrally formed or molded on the lower side or bottom face of a screw cap capable of being put on, moves into the central pour-out opening or spout. One or more drinking openings are molded or formed in the region of the lateral wall of the screw cap and the sealing plug or peg in the top surface. The multi-part plastic closure configured in such a manner is also capable of sealing relatively high inner pressures in the receptacle.

### BACKGROUND OF THE INVENTION

1. Field of the Invention

This invention relates to a multi-part plastic closure with a lower part capable of being put on a receptacle and which includes a pour-out mouth which extends upwards beyond the sealing region with the receptacle, and an annular wall with an outer thread, on which a screw cap is screwably held between a lower sealing position and an upper open position.

2. Discussion of Related Art

Closures of this type are attached to drinks bottles. The pour-out mouth is configured so that the user may drink from the drinks container without removing the closure, wherein the user puts the opening region of the closure directly into the mouth or takes it on the mouth. Closures built according to this concept have been called push-pull closures which permit a single-handed opening or closing of the closure, so that a sportsman may also open and close the closure while running or cycling by way of taking the closure in the mouth and pulling on the bottle, so that a cap is displaced from a closure position into an opening position, and a central sealing pin frees the centric opening.

Apart from this type of drinks closures, further similar multi-part plastic closures are on the market and known as a sports cap.

While such closures have only been applied until now for non-fizzy or non-carbonated drinks, more recently drinks have also been offered to sportsmen which contain carbon dioxide. The fizzy drinks have a more refreshing effect and this effect leads to the recreational sportsman drinking more, which is also desirable for health reasons.

With drinks containing carbon dioxide, a considerable excess pressure arises in the receptacle which may be a several bar pressure. With the known “push-pull” closures, the inner pressure leads to an opening effect of the closure which leads to an unsealeness, which not only leads to the reduction of the carbon dioxide content, but even to an escape of the fluid. Depending on the position of the receptacle, the gas pressure with respect to the plastic closure specifically lies behind the drink located therein and presses this to the outside through the closure.

This problem has been recognized and accordingly plastic closures have been offered which correspond to the previous push-pull closures, but are screwable and accordingly are able to withstand a higher inner pressure.

A closure of the initially mentioned type is known from PCT International Publication WO-01/27021. If the thread of such a closure is conceived as a self-locking thread, then the closure should not be able to open, even if a relatively higher inner pressure builds up. It has been shown that the carbon dioxide escapes even with these types of closures, even if the closure practically always remains closed because the inner pressure in the receptacle practically lies directly on the top surface of the screw cap. The design of the closure shown here has a lower part capable of being put on a receptacle, and has a pour-out mouth which extends upwards beyond the sealing region with the receptacle, and an annular wall with an outer thread onto which the screw cap is placed. The pour-out mouth has a sealing peg which is held centrically above the annular wall by radial ribs, while the screw cap includes a top surface with a drinking opening, into which the peg sealingly engages in the closed condition. In this case, the inner pressure which around the sealing peg is present communicating with the screw cap in a direct manner, also bears on the outer wall and the top surface of the screw cap. This inner pressure leads to a deformation of the top surface and the lateral wall of the screw cap, by which gas may get to the outside around the sealing peg, and thus the screw cap no longer can be held on the pour-out mouth in a sealed manner and thus even fluid reaching the outside via this region, particularly when the receptacle is shaken while participating in sports, and the inner pressure is accordingly high.

### SUMMARY OF THE INVENTION

It is one object of this invention to provide a multi-part plastic closure of the initially mentioned type but in which the disadvantages are resolved.

This object is achieved by a plastic closure according to this invention, having advantageous embodiments taught by this specification and in the claims, and the design and functioning is explained in the following description.

### BRIEF DESCRIPTION OF THE DRAWINGS

FIG. 1 shows a first embodiment, in a vertical diametrical section, wherein a closure is shown in an open position, with a pushed-over protective cap; and

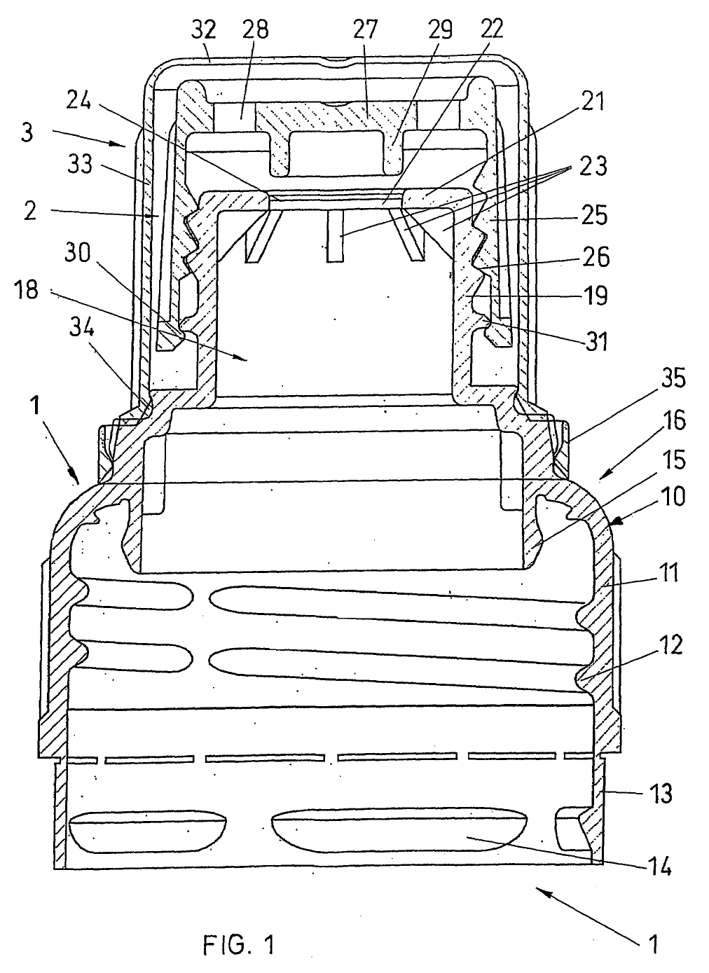

FIG. 2 shows a closure similar to that shown in FIG. 1, but without the protective cap.

### DESCRIPTION OF THE INVENTION

With the multi-part plastic closure according to this invention, a closure usually comprises three parts, specifically of a lower part 1 which may be screwed onto a container neck, and which assumes as sealing connection with neck, a screw cap 2 which is held on the lower part 1 and may be screwed from a closed position into an open position and vice versa, and a protective cap 3 which covers over the screw cap 2 and is held on the lower part 1 with a positive fit and a non-positive fit.

The lower part 1 comprises two regions which are arranged over one another, specifically a fastening region 10 by which the lower part 1 may be fastened on a container neck and creates the sealing between the lower part and the container, as well as a region arranged thereabove, which is indicated as a pour-out mouth 18. The fastening region 10 of the lower part 1 comprises an essentially peripheral skirt 11 in which an inner thread 12 is incorporated. A guarantee strip 13 is integrally formed on the lower edge of the skirt 11 via predetermined break location bridges and is held on the receptacle in a secured manner by way of a retaining bead 14. A shoulder which comprises a sealing region 16 connects to the skirt 11. A container neck inner sealing lip 15 is integrally formed in the sealing region 16 and in the assembled condition of the closure on the container, seals the closure with respect to the container neck in a bearing manner from the inside. The container neck is again sealed on the outer side by an annular sealing bead 17. A bearing inner pressure in the receptacle on which the closure is placed, as a result acts such that the container neck inner sealing lip 15 is pressed to the outside onto the container neck inner wall by the inner pressure, and thus the sealing effect is improved.

A pour-out mouth 18 is placed on, above the already mentioned fastening region 10 of the lower part 1, and is connected thereto as one piece. The pour-out mouth 18 has a cylindrical shape and is formed laterally by an annular wall 19 which is limited at the top by a top surface 21. The annular wall 19 has an outer thread 20. A pour-out opening 22 is formed centrally in the top surface 21. The screw cap 2 is screwed on the outer thread 20 of the pour-out mouth 18. The screw cap 2 comprises a cap lateral wall 25 with a corresponding inner thread 26 which hangs on the annular wall 19 with the outer thread 20. The screw cap 2 has a top surface 27 which terminates the cap lateral wall 25. At least one, advantageously two or four, drinking openings 28 are formed in the top surface 27 of the screw cap 2. A central peg 29 is integrally injected on the lower side of the top surface 27 and fits into the central pour-out opening 22 with a positive fit. Accordingly, the central pour-out opening 22 comprises sealing ribs and/or sealing channels 24.

In the closed condition of the closure, the screw cap 2 is screwed so far downwards that the peg 29 is sealingly inserted at least approximately completely in the central pour-out opening 22. In this condition, the top surface 27 of the screw cap 2 lies approximately on the top surface 21 of the pour-out mouth 18. If the inner pressure of the container acts, then this inner pressure also bears at the bottom on the top surface 21 of the pour-out mouth 18. In order to avoid or reduce deformations under the influence of pressure, the remaining annular top surface 21 has a multitude of stiffening means 23 designed in a rib-like manner and that form an additional connection between the top surface 21 and the annular wall 19 of the pour-out mouth 18. A remaining slight deformation under the effect of the bearing inner pressure may then lead to the top surface 21 acting on the lower side of the top surface 27 of the screw cap 2 with a certain residual pressure. Thus, the annular top surface 21 is deformed so that this lies on the drinking opening 28 in a practically sealing manner. The screw cap 2 additionally comprises a lower retaining bead 30 at the end. This retaining bead 30 prevents a screwing-off of the screw cap 2. Accordingly, an annular abutment 31 is integrally formed on the pour-out mouth 18 below the outer thread 20. In this upper open position of the closure, the peg 29 lies completely outside the central pour-out opening 22 in a distanced manner. A throughflow is thus free, which permits a comfortable drinking. The maximal distance of the peg 29 above the pour-out opening 22 is selected with regard to design so that the throughflow is only possible in a reduced manner, in order thus to ensure that not too much content may flow out per unit of time.

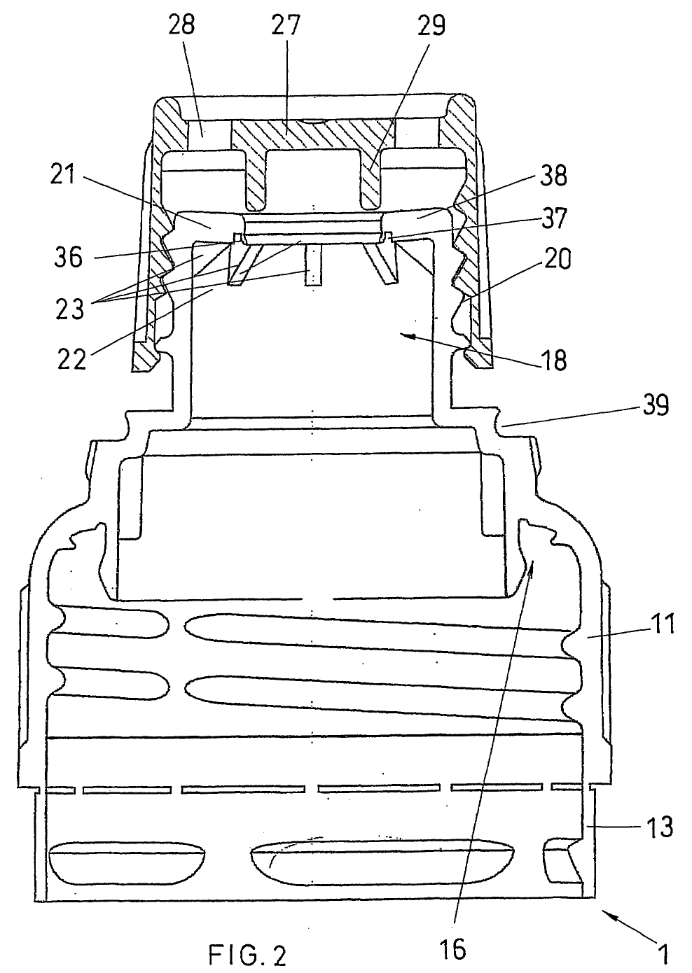

A screw cap 3 is provided above the protective cap 2 which in FIG. 2 is omitted for the purpose of clarity. The protective cap 3 accommodates no compression forces and is merely pushed on with a non-positive fit. The protective cap 3 has a protective cap top surface 32 to which a peripheral protective cap lateral wall 33 connects. A retaining bead 34 which engages into a corresponding retaining groove 39 is integrally formed on the protective cap lateral wall 33 at the end. A guarantee strip 35 is integrally formed with the lateral wall 33 offset outwards and via breakage locations. The guarantee strip 35 serves for the tamper-proof guarantee and here is removed on opening for the first time, or remains in this position and is merely separated away.

For improving the sealing between the top surface 21, which as already mentioned is practically only an annular top surface 38, and the peg 29, the central pour-out opening 22 has a peripheral sealing lip 36 directed to the inner side of the container. An annular groove 37 is provided peripherally around the sealing lip, so that the complete inner pressure may be effective on this sealing lip 36.

The complete inner pressure of the receptacle is divided onto two parts by the design of the closure according to this invention, specifically on one hand onto the annular top surface 38 of the pour-out mouth 18, and on the other hand onto the relatively small surface of the sealing surface 27 in the region within the sealing peg 29. The sealing peg 29 additionally acts as a reinforcement of the top surface 27 of the screw cap 2. In contrast to known closures of this type, the inner pressure of the receptacle is divided up better and possible deformations due to the bearing inner pressure are accommodated by the mentioned stiffener or stiffening means 23 as well as the stiffening by the peg 29.

1. A multi-part plastic closure with a lower part capable (1) of being put on a receptacle and comprising a pour-out mouth (18) extending upwards beyond a sealing region (16) with the receptacle, an annular wall (19) with an outer thread (20) on which a screw cap (2) is screwably held between a lower sealing position and an upper open position, the pour-out mouth (18) comprising a top surface (21) connecting to the annular wall (19) with a central pour-out opening (22), wherein a stiffener (23) formed in a rib-like manner forms a connection between the annular wall (19) and the top surface (21) to prevent a deformation of the pour-out mouth (18) under influence of an inner pressure, and the screw cap (2) having a central peg (29) which sealingly engages into the pour-out opening (22) in a closed condition of the closure, and at least one drinking opening (28) arranged between the cap lateral wall (25) of the screw cap (2) and the centric peg (29).

2. A multi-part plastic closure according to claim 1, wherein the screw cap (2) on an inner side of the peripheral wall comprises a retaining bead (30) at an end which cooperates with an annular abutment (31) which surrounds the annular wall (19) below the outer thread (20) and prevents a screwing-off of the screw cap.

3. A multi-part plastic closure according to claim 1, wherein the pour-out opening (22) has sealing means which cooperate with the peg of the screw cap (2).

4. A multi-part plastic closure according to claim 3, wherein the sealing means is a sealing lip which is integrally formed on a lower side of the top surface and which surrounds the pour-out opening at an edge.

5. A multi-part plastic closure according to claim 4, wherein the top surface (21) on a lower side comprises an annular groove (37) bordering the sealing lip (36).

6. A multi-part plastic closure according to claim 1, wherein the lower part (1) has a guarantee strip (35).

7. A multi-part plastic closure according to claim 1, wherein a protective cap (3) is pushable on the lower part (1) with one of a non-positive fit and a positive fit, past the screw cap (2).

8. A multipart plastic closure according to claim 7, wherein the protective cap (3) has a guarantee strip (35) and is held on the lower part (1) of the multi-part plastic closure.

9. A multi-part plastic closure according to claim 1, wherein a plurality of drinking openings (28) are arranged so that in the closed condition of the closure the drinking openings (28) lie at least approximately in a sealing manner on a remaining annular top surface (38) of the pour-out mouth (18).
